(19) United States
(12) Patent Application Publication
(10) Pub. No.: US 2025/0035585 A1
(43) Pub. Date: Jan. 30, 2025

(54) CALCULATING ELECTROPHORETIC MOBILITY OF A SAMPLE BY EXTRACTING SPECTRA

(71) Applicant: Wyatt Technology, LLC, Goleta, CA (US)

(72) Inventors: Grzegorz M. Dmochowski, Goleta, CA (US); David Rahmlow, Goleta, CA (US); Steven P. Trainoff, Santa Barbare, CA (US); Paul Viren, Santa Barbara, CA (US)

(21) Appl. No.: 18/777,723

(22) Filed: Jul. 19, 2024

Related U.S. Application Data
(60) Provisional application No. 63/528,535, filed on Jul. 24, 2023.

(51) Int. Cl. G01N 27/447

(52) U.S. Cl. CPC G01N 27/44721; G01N 27/44756

(57) ABSTRACT

Described is a method, system, and computer program product of calculating electrophoretic mobility of a sample by extracting spectra. In an embodiment, the method, system, and computer program product include receiving from a detector light intensity detector data corresponding to a sample, splicing the intensity detector data into positive intensity detector data segments and negative intensity detector data segments, stitching together the positive intensity detector data segments and the negative intensity detector data segments, resulting in positive stitched data and negative stitched data, respectively, applying a Fast Fourier Transform to the positive stitched data and the negative stitched data, resulting in a positive stitched spectrum and a negative stitched spectrum, respectively, fitting the positive stitched spectrum and negative stitched spectrum to a fitting function, resulting in a positive center frequency and a negative center frequency, respectively, and processing the center frequencies to calculate the electrophoretic mobility of sample particles.

### RELATED APPLICATION

This application claims priority to U.S. Provisional Patent Application No. 63/528,535 filed on Jul. 24, 2023 and titled “Calculating Electrophoretic Mobility of a Sample by Extracting Spectra”, the entirety of which is incorporated by reference herein.

### BACKGROUND

The present disclosure relates to electrophoretic mobility, and more specifically, to calculating electrophoretic mobility of a sample by extracting spectra.

### SUMMARY

The present disclosure describes a computer implemented method, a system, and a computer program product of calculating electrophoretic mobility of a sample by extracting spectra. In an exemplary embodiment, the computer implemented method, the system, and the computer program product include (1) receiving, by a computer system, from a detector light intensity detector data corresponding to a sample as a function of time, where the intensity detector data includes a beat signal, (2) executing, by the computer system, a set of logical operations splicing the intensity detector data into time segments, where a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments, (3) executing, by the computer system, a set of logical operations stitching together the positive intensity detector data segments, resulting in positive stitched data, (4) executing, by the computer system, a set of logical operations stitching together the negative intensity detector data segments, resulting in negative stitched data, (5) executing, by the computer system, a set of logical operations applying a Fast Fourier Transform to the positive stitched data with respect to the beat signal, resulting in a positive stitched spectrum, (6) executing, by the computer system, a set of logical operations applying the Fast Fourier Transform to the negative stitched data with respect to the beat signal, resulting in a negative stitched spectrum, (7) executing, by the computer system, a set of logical operations fitting the positive stitched spectrum to a fitting function, resulting in a positive center frequency of a positive peak position of the positive stitched spectrum, (8) executing, by the computer system, a set of logical operations fitting the negative stitched spectrum to the fitting function, resulting in a negative center frequency of a negative peak position of the negative stitched spectrum, and (9) executing, by the computer system, a set of logical operations processing the positive center frequency and the negative center frequency according to a processing function, allowing for calculating the electrophoretic mobility of particles of the sample.

### BRIEF DESCRIPTION OF THE DRAWINGS

FIG. 1A depicts a flowchart in accordance with an exemplary embodiment.

FIG. 1B depicts a flowchart in accordance with an exemplary embodiment.

FIG. 2A depicts a flowchart in accordance with an exemplary embodiment.

FIG. 2B depicts a flowchart in accordance with an exemplary embodiment.

FIG. 3A depicts a flowchart in accordance with an exemplary embodiment.

FIG. 3B depicts a flowchart in accordance with an exemplary embodiment.

FIG. 4A depicts a graph in accordance with an embodiment.

FIG. 4B depicts a graph in accordance with an embodiment.

FIG. 4C depicts a graph in accordance with an embodiment.

FIG. 5 depicts a graph in accordance with an embodiment.

FIG. 6 depicts a graph in accordance with an embodiment.

FIG. 7 depicts a graph in accordance with an embodiment.

FIG. 8 depicts a computer system in accordance with an exemplary embodiment.

### DETAILED DESCRIPTION

The present disclosure describes a computer implemented method, a system, and a computer program product of calculating electrophoretic mobility of a sample by extracting spectra. In an exemplary embodiment, the computer implemented method, the system, and the computer program product include (1) receiving, by a computer system, from a detector light intensity detector data corresponding to a sample as a function of time, where the intensity detector data includes a beat signal, (2) executing, by the computer system, a set of logical operations splicing the intensity detector data into time segments, where a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments, (3) executing, by the computer system, a set of logical operations stitching together the positive intensity detector data segments, resulting in positive stitched data, (4) executing, by the computer system, a set of logical operations stitching together the negative intensity detector data segments, resulting in negative stitched data, (5) executing, by the computer system, a set of logical operations applying a Fast Fourier Transform to the positive stitched data with respect to the beat signal, resulting in a positive stitched spectrum, (6) executing, by the computer system, a set of logical operations applying the Fast Fourier Transform to the negative stitched data with respect to the beat signal, resulting in a negative stitched spectrum, (7) executing, by the computer system, a set of logical operations fitting the positive stitched spectrum to a fitting function, resulting in a positive center frequency of a positive peak position of the positive stitched spectrum, (8) executing, by the computer system, a set of logical operations fitting the negative stitched spectrum to the fitting function, resulting in a negative center frequency of a negative peak position of the negative stitched spectrum, and (9) executing, by the computer system, a set of logical operations processing the positive center frequency and the negative center frequency according to a processing function, allowing for calculating the electrophoretic mobility of particles of the sample. In an embodiment, the detector is selected from the group consisting of a photodiode detector, a CMOS detector, a photomultiplier tube, and a balometer. In an embodiment, a frequency of the beat signal changes in time, and a center frequency of the beat signal changes as a result of applying an alternating electric field to the sample.

In an embodiment, the Fast Fourier Transform is selected from the group consisting of a power spectrum and a periodogram. In an embodiment, the fitting function includes a non-linear, least square, Lorenz function. For example, the fitting function is a non-linear, least square, Lorenz function. As an example, when an electric field of a first polarity (e.g., positive polarity) is applied to the sample, the beat signal could have a frequency of 7995 Hz, while when an electric filed of the opposite polarity (e.g., negative polarity) is applied to the sample, the beat signal could have a frequency of 8005 Hz, leading to a 5 Hz shift in the frequency of the beat signal, where the shift is proportional to the electrophoretic mobility of the particles in the sample. In an embodiment, the processing function includes a proportionality function whereby the electrophoretic mobility of the particles of the sample is proportional to a difference between the positive center frequency and the negative center frequency. For example, the processing function is a proportionality function whereby the electrophoretic mobility of the particles of the sample is proportional to a difference between the positive center frequency and the negative center frequency.

In an exemplary embodiment, the computer implemented method, the system, and the computer program product include (1) receiving, by a computer system, from a detector light intensity detector data corresponding to a sample as a function of time, where the intensity detector data includes a beat signal, (2) executing, by the computer system, a set of logical operations splicing the intensity detector data into time segments, where a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments, (3) executing, by the computer system, a set of logical operations truncating the positive intensity detector data segments to remove positive data artifacts from the positive intensity detector data segments, resulting in truncated positive data segments, (4) executing, by the computer system, a set of logical operations truncating the negative intensity detector data segments to remove negative data artifacts from the positive intensity detector data segments, resulting in truncated negative data segments, (5) executing, by the computer system, a set of logical operations stitching together the truncated positive intensity detector data segments, resulting in positive stitched data, (6) executing, by the computer system, a set of logical operations stitching together the truncated negative intensity detector data segments, resulting in negative stitched data, (7) executing, by the computer system, a set of logical operations applying a Fast Fourier Transform to the positive stitched data with respect to the beat signal, resulting in a positive stitched spectrum, (8) executing, by the computer system, a set of logical operations applying the Fast Fourier Transform to the negative stitched data with respect to the beat signal, resulting in a negative stitched spectrum, (9) executing, by the computer system, a set of logical operations fitting the positive stitched spectrum to a fitting function, resulting in a positive center frequency of a positive peak position of the positive stitched spectrum, (10) executing, by the computer system, a set of logical operations fitting the negative stitched spectrum to the fitting function, resulting in a negative center frequency of a negative peak position of the negative stitched spectrum, and (11) executing, by the computer system, a set of logical operations processing the positive center frequency and the negative center frequency according to a processing function, allowing for calculating the electrophoretic mobility of particles of the sample. In an embodiment, the truncating allows for avoiding discontinuities in the time domain of the intensity detector data that would lead to artifacts in the frequency domain, resulting in judicious truncation of the intensity detector data. In an embodiment, the truncating removes a discrete number of data points in the intensity detector data in order to adjust the phase of the intensity detector data (e.g., by removing 1 data point, the phase could be adjusted by 10 degrees) (e.g., by removing 2 data points, the phase could be adjusted by 20 degrees).

In an exemplary embodiment, the computer implemented method, the system, and the computer program product include (1) receiving by a computer system, from a detector light intensity detector data corresponding to a sample as a function of time, where the intensity detector data comprises a beat signal, (2) executing, by the computer system, a set of logical operations splicing the intensity detector data into time segments, where a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments, (3) executing, by the computer system, a set of logical operations aligning a phase of the positive intensity detector data segments to remove positive data artifacts from the positive intensity detector data segments, resulting in phase-aligned positive data segments, (4) executing, by the computer system, a set of logical operations aligning a phase of the negative intensity detector data segments to remove negative data artifacts from the negative intensity detector data segments, resulting in phase-aligned negative data segments, (5) executing, by the computer system, a set of logical operations stitching together the phase-aligned positive data segments, resulting in positive stitched data, (6) executing, by the computer system, a set of logical operations stitching together the phase-aligned negative data segments, resulting in negative stitched data, (7) executing, by the computer system, a set of logical operations applying a Fast Fourier Transform to the positive stitched data with respect to the beat signal, resulting in a positive stitched spectrum, (8) executing, by the computer system, a set of logical operations applying the Fast Fourier Transform to the negative stitched data with respect to the beat signal, resulting in a negative stitched spectrum, (9) executing, by the computer system, a set of logical operations fitting the positive stitched spectrum to a fitting function, resulting in a positive center frequency of a positive peak position of the positive stitched spectrum, (10) executing, by the computer system, a set of logical operations fitting the negative stitched spectrum to the fitting function, resulting in a negative center frequency of a negative peak position of the negative stitched spectrum, and (11) executing, by the computer system, a set of logical operations processing the positive center frequency and the negative center frequency according to a processing function, allowing for calculating the electrophoretic mobility of particles of the sample. In an embodiment, the aligning allows for avoiding discontinuities in the time domain of the intensity detector data that would lead to artifacts in the frequency domain, resulting in judicious phase alignment/judicious truncation of the intensity detector data. In an embodiment, the aligning removes a discrete number of data points in the intensity detector data in order to adjust the phase of the intensity detector data (e.g., by removing 1 data point, the phase could be adjusted by 10 degrees) (e.g., by removing 2 data points, the phase could be adjusted by 20 degrees).

In an embodiment, the splicing separates the original time domain data into two portions, each one containing only a single frequency shift (either positive or negative), the beat signal. For example, knowing the switching rate for the electric field allows for the splicing/splitting of the data into positive and negative segments, and also allows for the stitching together the positive segments together and stitching all the negative segments together.

In an embodiment, applying the Fast Fourier Transform (FFT) of the either one of these spliced data yields a spectrum that contains only a single frequency shift, allowing for the determination of the sign of the charge of the sample. Knowing the sign of the charge, in an embodiment, simplifies the fitting procedure required to extract the electrophoretic mobility of the sample.

In an embodiment, the truncating fits sine waves to the data and calculates the number of samples that should be removed to make the phases match. In an embodiment the truncating deletes data points from the beginning of each new packet of data, and then the stitching outputs the stitched positive and negative streams on two separate data pipes. In an embodiment, the truncating calculates the maximum number of data samples/data points that could be removed during stitching (e.g., a small percentage of all of the data points), and then truncates the interval data/data segments to contain the same minimal number of points that the FFT needs to use.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns.

### Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated generally based on size, mass, or column affinity, the samples may be subjected to analysis by means of light scattering, refractive index, ultraviolet absorption, electrophoretic mobility, and viscometric response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photodetector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is a SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam (usually from a laser source producing a collimated beam of monochromatic light) that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photodetectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to Zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity, known as the mobility, that is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F(κa) to get from the mobility to a zeta potential).

Electrophoretic light scattering (ELS) involves applying an electric field to the sample in order to exert a force on the (charged) particles. In order to prevent the accumulation of charged particles onto the electrodes used to establish this electric field in an ELS measurement instrument, an alternating field is used, whose direction is switched (e.g., between positive and negative directions) rapidly enough to prevent charge build-up. During the application of a positive electric field, the sample acquires a positive velocity component, which leads to a positive Doppler frequency shift on the light that is scattered from the sample. During the application of a negative electric field, the sample acquires a velocity component in the opposite direction, which leads to a negative Doppler shift on the light that is scattered from the sample.

### Fourier Transform

The Fourier Transform breaks a waveform (a function or signal) into an alternate representation, characterized by the sine and cosine functions of varying frequencies. The Fourier Transform shows that any waveform can be re-written as the sum of sinusoidals. The Fourier Transform decomposes any signal into a sum of simple sine and cosine waves whose frequency, amplitude and phase could be measure. The Fourier transform can be applied to continuous or discrete waves/signals.

### Discrete Fourier Transform

The Discrete Fourier Transform (DFT) transforms a sequence of evenly spaced signal to the information about the frequency of all the sine waves needed to sum to the time domain signal.

### Fast Fourier Transform

The Fast Fourier Transform (FFT) calculates the DFT of a sequence by recursively breaking the DFT into smaller DFTs to bring down the computation. As a result, the FFT reduces the complexity of the DFT from O(n2) to O(n log n), where n is the size of the data. This reduction in computation time is significant especially for data with large N. sample. of the data. This reduction in computation time is significant especially for data with large N. sample.

### Data Fitting

Data fitting fits mathematical models/functions to data and analyzes the accuracy of the fit. Data fitting techniques, including mathematical equations and nonparametric methods, may model data acquired by measurement devices/instruments.

### Least Squares Fitting

Least Squares Fitting finds the best-fitting curve to a given set of points by minimizing the sum of the squares of the offsets (i.e., the residuals) of the points from the curve. The sum of the squares of the offsets is used instead of the offset absolute values because this allows the residuals to be treated as a continuous differentiable quantity. The linear least squares fitting technique is the simplest and most commonly applied form of linear regression and provides a solution to the problem of finding the best fitting straight line through a set of points, waves/signals.

### Nonlinear Least Squares Fitting

Nonlinear least squares fitting to a number of unknown parameters applies linear least squares fitting iteratively to a linearized form of the function until convergence is achieved. However, it is often also possible to linearize a nonlinear function at the outset and still use linear methods for determining fit parameters without resorting to iterative procedures.

### Gaussian Function Fitting

The Gaussian function is symmetric about its center point, has a finite integral, and is such that it does not have exceedingly large tails or other components that extend out to a significant degree. The Gaussian function/curve is the classic “bell-shaped” or “normal” curve/distribution.

### Lorentzian Function Fitting

The Lorentzian function also is symmetric about its center point, has a finite integral, and is such that it does not have exceedingly large tails or other components that extend out to a significant degree. However, the Lorentzian function/curve is somewhat narrower around its maximum and it extends out a little more than the Gaussian on its sides (i.e., the Lorentzian function/curve has “wings”. The Lorentzian function is used for pre-processing of the background in a spectrum and for fitting of the spectral intensity. Real spectral shapes are better approximated by the Lorentzian function than the Gaussian function.

### Current Technologies

Current ELS measurement instruments typically switch the electric field at a frequency of 20 Hz, such that the original time domain data has alternating 50 ms segments, each of which have either a positive or a negative frequency shift imprinted on them. The frequency domain representation (i.e., the “spectrum” or the Fast Fourier Transform) of this entire stretch of data would then have both frequency shifts imprinted on it, which leads to more difficult fitting and the inability to detect the sign of the charge of the sample. Thus, there is a need for calculating electrophoretic mobility of a sample by extracting spectra.

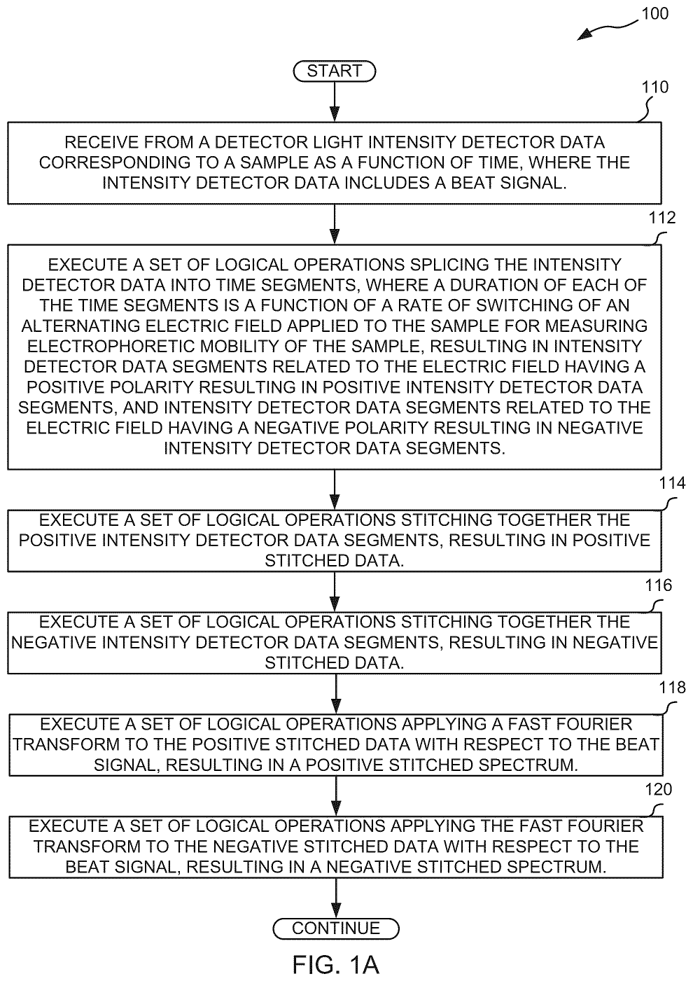

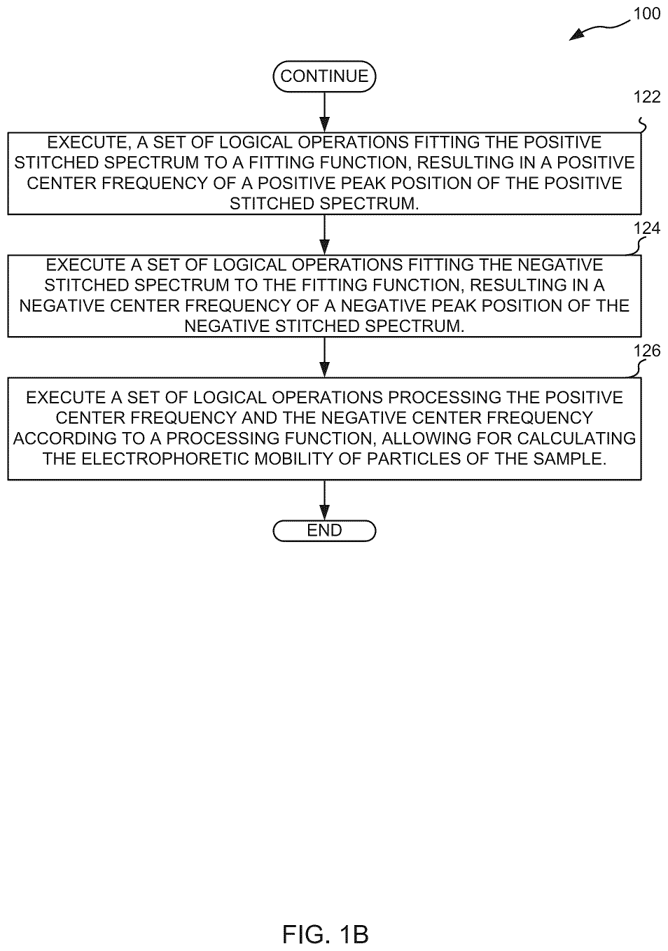

Referring to FIG. 1A and FIG. 1B, in an exemplary embodiment, the computer implemented method, the system, and the computer program product are configured to perform an operation 110 of receiving, by a computer system, from a detector, light intensity detector data corresponding to a sample as a function of time, where the intensity detector data includes a beat signal, an operation 112 of executing, by the computer system, a set of logical operations splicing the intensity detector data into time segments, where a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments, an operation 114 of executing, by the computer system, a set of logical operations stitching together the positive intensity detector data segments, resulting in positive stitched data, an operation 116 of executing, by the computer system, a set of logical operations stitching together the negative intensity detector data segments, resulting in negative stitched data, an operation 118 of executing, by the computer system, a set of logical operations applying a Fast Fourier Transform to the positive stitched data with respect to the beat signal, resulting in a positive stitched spectrum, an operation 120 of executing, by the computer system, a set of logical operations applying the Fast Fourier Transform to the negative stitched data with respect to the beat signal, resulting in a negative stitched spectrum, an operation 122 of executing, by the computer system, a set of logical operations fitting the positive stitched spectrum to a fitting function, resulting in a positive center frequency of a positive peak position of the positive stitched spectrum, an operation 124 of executing, by the computer system, a set of logical operations fitting the negative stitched spectrum to the fitting function, resulting in a negative center frequency of a negative peak position of the negative stitched spectrum, and an operation 126 of executing, by the computer system, a set of logical operations processing the positive center frequency and the negative center frequency according to a function, allowing for calculating the electrophoretic mobility of particles of the sample.

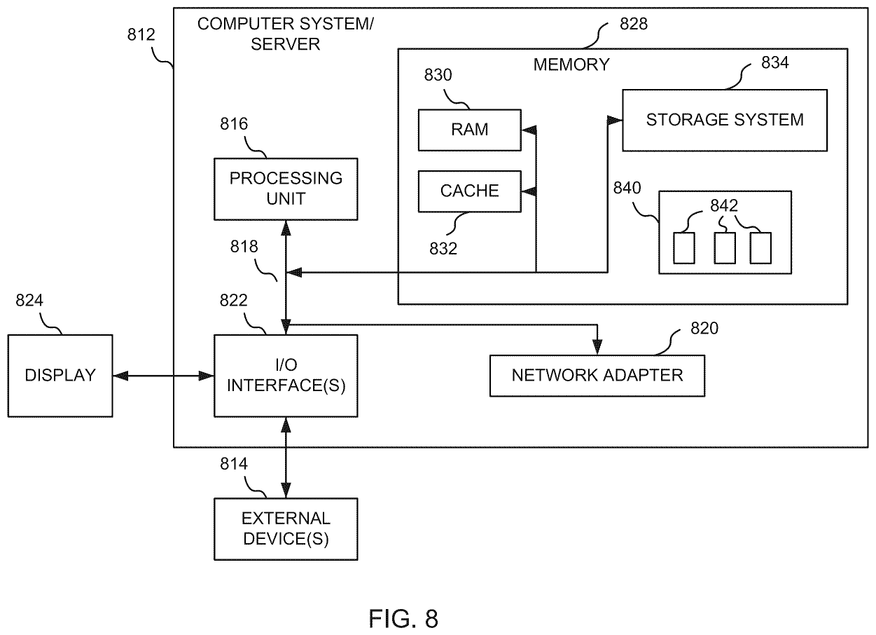

In an exemplary embodiment, the computer system is a standalone computer system, such as computer system 800 shown in FIG. 8, a network of distributed computers, where at least some of the computers are computer systems such as computer system 800 shown in FIG. 8, or a cloud computing node server, such as computer system 800 shown in FIG. 8. In an embodiment, the computer system is a computer system 800 as shown in FIG. 8, that executes a calculating electrophoretic mobility of a sample script or computer software application that carries out the operations of at least method 100. In an embodiment, the computer system is a computer system/server 812 as shown in FIG. 8, that executes a calculating electrophoretic mobility of a sample script or computer software application that carries out the operations of at least method 100. In an embodiment, the computer system is a processing unit 816 as shown in FIG. 8, that executes a calculating electrophoretic mobility of a sample script or computer software application that carries out the operations of at least method 100.

In an embodiment, the computer system is a computer system 800 as shown in FIG. 8, that executes a calculating electrophoretic mobility of a sample script or computer software application that carries out at least operations 110, 112, 114, 116, 118, 120, 122, 124, and 126. In an embodiment, the computer system is a computer system/server 812 as shown in FIG. 8, that executes a calculating electrophoretic mobility of a sample script or computer software application that carries out at least operations 110, 112, 114, 116, 118, 120, 122, 124, and 126. In an embodiment, the computer system is a processing unit 816 as shown in FIG. 8, that a calculating electrophoretic mobility of a sample script or computer software application that carries out at least operations 110, 112, 114, 116, 118, 120, 122, 124, and 126.

### Truncating

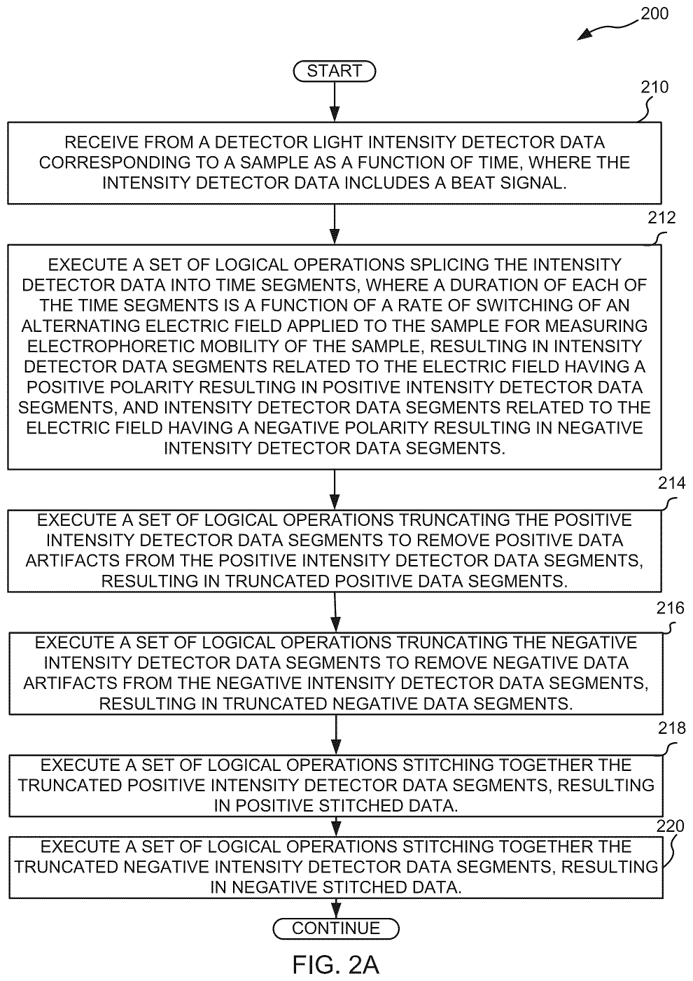

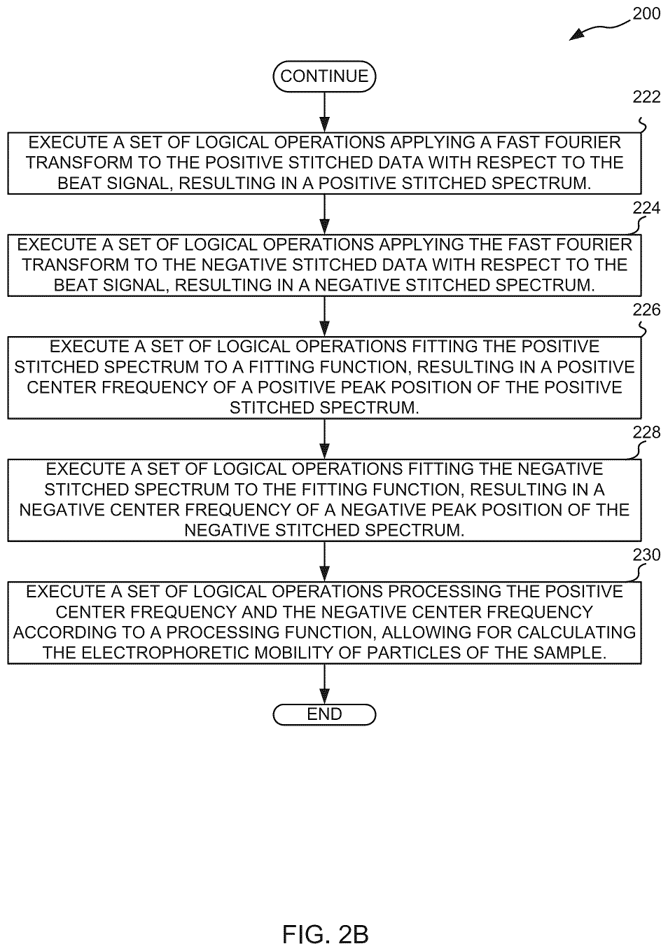

Referring to FIG. 2A and FIG. 2B, in an exemplary embodiment, the computer implemented method, the system, and the computer program product are configured to perform an operation 210 of receiving, by a computer system, from a detector light intensity detector data corresponding to a sample as a function of time, where the intensity detector data includes a beat signal, an operation 212 of executing, by the computer system, a set of logical operations splicing the intensity detector data into time segments, where a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments, an operation 214 of executing, by the computer system, a set of logical operations truncating the positive intensity detector data segments to remove positive data artifacts from the positive intensity detector data segments, resulting in truncated positive data segments, an operation 216 of executing, by the computer system, a set of logical operations truncating the negative intensity detector data segments to remove negative data artifacts from the negative intensity detector data segments, resulting in truncated negative data segments, an operation 218 of executing, by the computer system, a set of logical operations stitching together the truncated positive intensity detector data segments, resulting in positive stitched data, an operation 220 of executing, by the computer system, a set of logical operations stitching together the truncated negative intensity detector data segments, resulting in negative stitched data, an operation 222 of executing, by the computer system, a set of logical operations applying a Fast Fourier Transform to the positive stitched data with respect to the beat signal, resulting in a positive stitched spectrum, an operation 224 of executing, by the computer system, a set of logical operations applying the Fast Fourier Transform to the negative stitched data with respect to the beat signal, resulting in a negative stitched spectrum, an operation 226 of executing, by the computer system, a set of logical operations fitting the positive stitched spectrum to a fitting function, resulting in a positive center frequency of a positive peak position of the positive stitched spectrum, an operation 228 of executing, by the computer system, a set of logical operations fitting the negative stitched spectrum to the fitting function, resulting in a negative center frequency of a negative peak position of the negative stitched spectrum, and an operation 230 of executing, by the computer system, a set of logical operations processing the positive center frequency and the negative center frequency according to a processing function, allowing for calculating the electrophoretic mobility of particles of the sample. In an embodiment, the computer implemented method, the system, and the computer program product are further configured to perform a further operation of executing, by the computer system, a set of logical operations determining phase changes for the intensity detector data segments. For example, the determining operation assists in the performance of truncating operations 214 and 216. In an embodiment, the determining operation includes an operation of executing, by the computer system, a set of logical operations applying sinusoidal functions to the intensity detector data segments, resulting in phase shift values corresponding to the phase changes associated with truncating operations 214 and 216.

In an exemplary embodiment, the computer system is a standalone computer system, such as computer system 800 shown in FIG. 8, a network of distributed computers, where at least some of the computers are computer systems such as computer system 800 shown in FIG. 8, or a cloud computing node server, such as computer system 800 shown in FIG. 8. In an embodiment, the computer system is a computer system 800 as shown in FIG. 8, that executes a calculating electrophoretic mobility of a sample script or computer software application that carries out the operations of at least method 200. In an embodiment, the computer system is a computer system/server 812 as shown in FIG. 8, that executes a calculating electrophoretic mobility of a sample script or computer software application that carries out the operations of at least method 200. In an embodiment, the computer system is a processing unit 816 as shown in FIG. 8, that executes a calculating electrophoretic mobility of a sample script or computer software application that carries out the operations of at least method 200.

In an embodiment, the computer system is a computer system 800 as shown in FIG. 8, that executes a calculating electrophoretic mobility of a sample script or computer software application that carries out at least operations 210, 212, 214, 216, 218, 220, 222, 224, 226, 228, and 230. In an embodiment, the computer system is a computer system/server 812 as shown in FIG. 8, that executes a calculating electrophoretic mobility of a sample script or computer software application that carries out at least operations 210, 212, 214, 216, 218, 220, 222, 224, 226, 228, and 230. In an embodiment, the computer system is a processing unit 816 as shown in FIG. 8, that a calculating electrophoretic mobility of a sample script or computer software application that carries out at least operations 210, 212, 214, 216, 218, 220, 222, 224, 226, 228, and 230.

### Aligning Phases

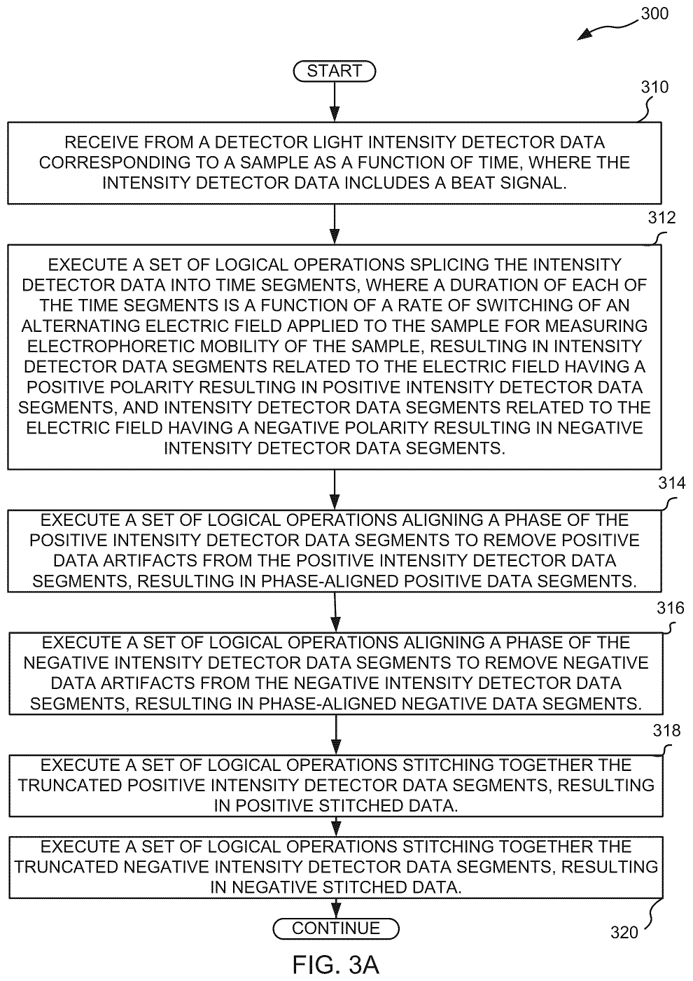

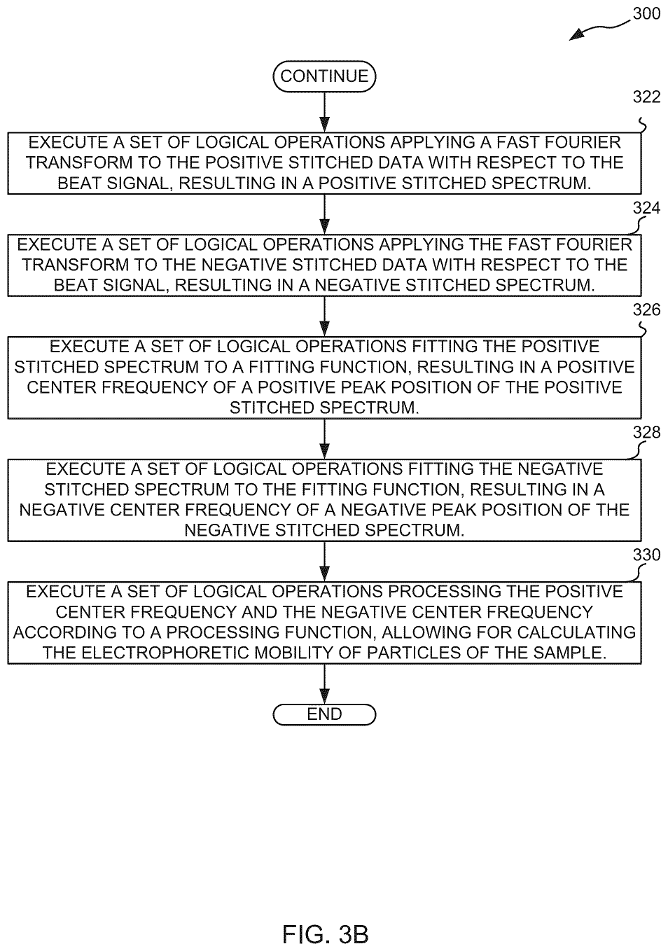

Referring to FIG. 3A and FIG. 3B, in an exemplary embodiment, the computer implemented method, the system, and the computer program product are configured to perform an operation 310 of receiving by a computer system, from a detector light intensity detector data corresponding to a sample as a function of time, where the intensity detector data comprises a beat signal, an operation 312 of executing, by the computer system, a set of logical operations splicing the intensity detector data into time segments, where a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments, an operation 314 of executing, by the computer system, a set of logical operations aligning a phase of the positive intensity detector data segments to remove positive data artifacts from the positive intensity detector data segments, resulting in phase-aligned positive data segments, an operation 316 of executing, by the computer system, a set of logical operations aligning a phase of the negative intensity detector data segments to remove negative data artifacts from the negative intensity detector data segments, resulting in phase-aligned negative data segments, an operation 318 of executing, by the computer system, a set of logical operations stitching together the phase-aligned positive data segments, resulting in positive stitched data, an operation 320 of executing, by the computer system, a set of logical operations stitching together the phase-aligned negative data segments, resulting in negative stitched data, an operation 322 of executing, by the computer system, a set of logical operations applying a Fast Fourier Transform to the positive stitched data with respect to the beat signal, resulting in a positive stitched spectrum, an operation 324 of executing, by the computer system, a set of logical operations applying the Fast Fourier Transform to the negative stitched data with respect to the beat signal, resulting in a negative stitched spectrum, an operation 326 of executing, by the computer system, a set of logical operations fitting the positive stitched spectrum to a fitting function, resulting in a positive center frequency of a positive peak position of the positive stitched spectrum, an operation 328 of executing, by the computer system, a set of logical operations fitting the negative stitched spectrum to the fitting function, resulting in a negative center frequency of a negative peak position of the negative stitched spectrum, and an operation 330 of executing, by the computer system, a set of logical operations processing the positive center frequency and the negative center frequency according to a processing function, allowing for calculating the electrophoretic mobility of particles of the sample.

In an embodiment, the computer implemented method, the system, and the computer program product are further configured to perform a further operation of executing, by the computer system, a set of logical operations determining phase changes for the intensity detector data segments. For example, the determining operation assists in the performance of aligning operations 314 and 316. In an embodiment, the determining operation includes an operation of executing, by the computer system, a set of logical operations applying sinusoidal functions to the intensity detector data segments, resulting in phase shift values corresponding to the phase changes associated with aligning operations 314 and 316.

In an exemplary embodiment, the computer system is a standalone computer system, such as computer system 800 shown in FIG. 8, a network of distributed computers, where at least some of the computers are computer systems such as computer system 800 shown in FIG. 8, or a cloud computing node server, such as computer system 800 shown in FIG. 8. In an embodiment, the computer system is a computer system 800 as shown in FIG. 8, that executes a calculating electrophoretic mobility of a sample script or computer software application that carries out the operations of at least method 300. In an embodiment, the computer system is a computer system/server 812 as shown in FIG. 8, that executes a calculating electrophoretic mobility of a sample script or computer software application that carries out the operations of at least method 300. In an embodiment, the computer system is a processing unit 816 as shown in FIG. 8, that executes a calculating electrophoretic mobility of a sample script or computer software application that carries out the operations of at least method 300.

In an embodiment, the computer system is a computer system 800 as shown in FIG. 8, that executes a calculating electrophoretic mobility of a sample script or computer software application that carries out at least operations 310, 312, 314, 316, 318, 320, 322, 324, 326, 328, and 330. In an embodiment, the computer system is a computer system/server 812 as shown in FIG. 8, that executes a calculating electrophoretic mobility of a sample script or computer software application that carries out at least operations 310, 312, 314, 316, 318, 320, 322, 324, 326, 328, and 330. In an embodiment, the computer system is a processing unit 816 as shown in FIG. 8, that a calculating electrophoretic mobility of a sample script or computer software application that carries out at least operations 310, 312, 314, 316, 318, 320, 322, 324, 326, 328, and 330.

### Example

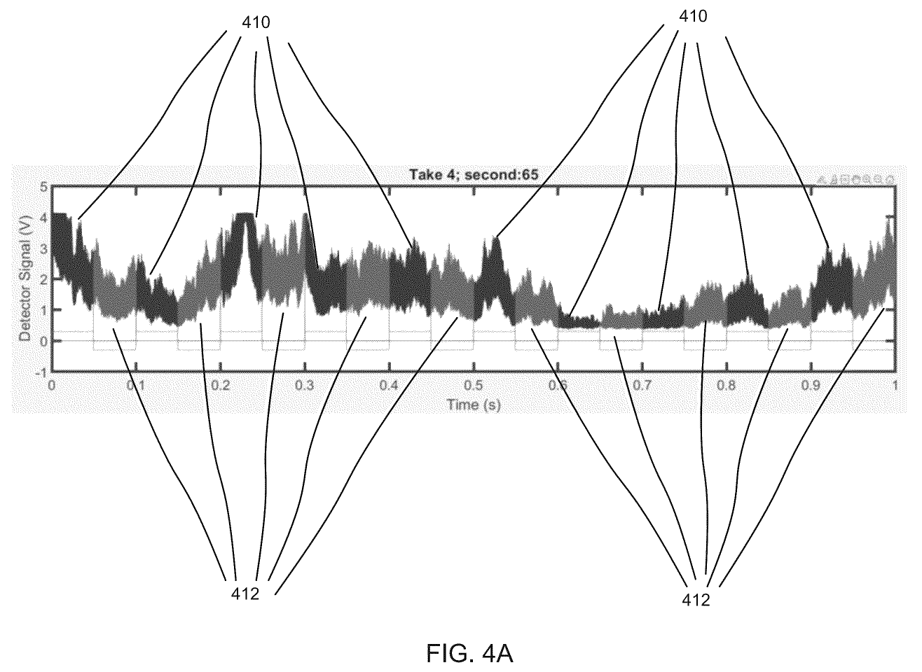

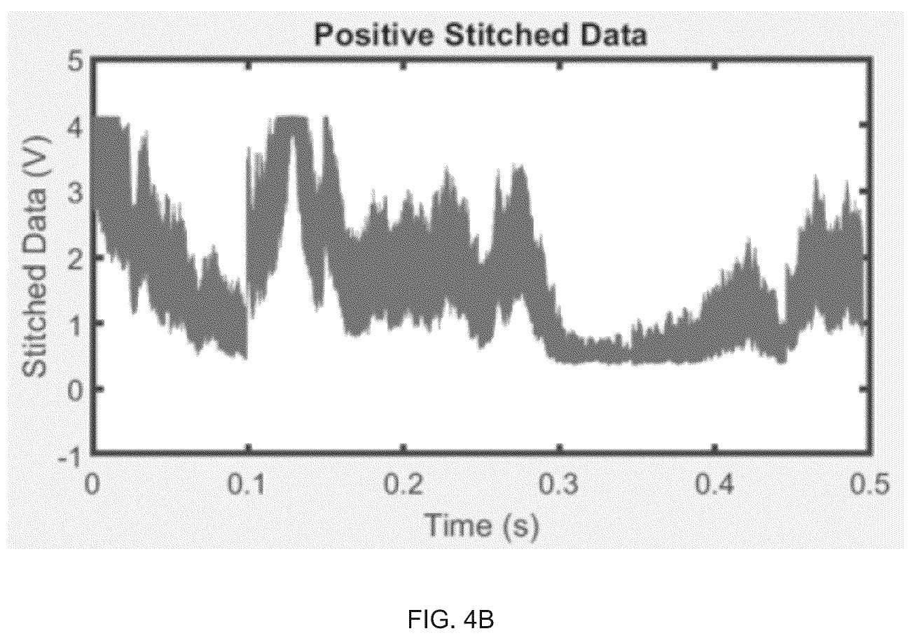

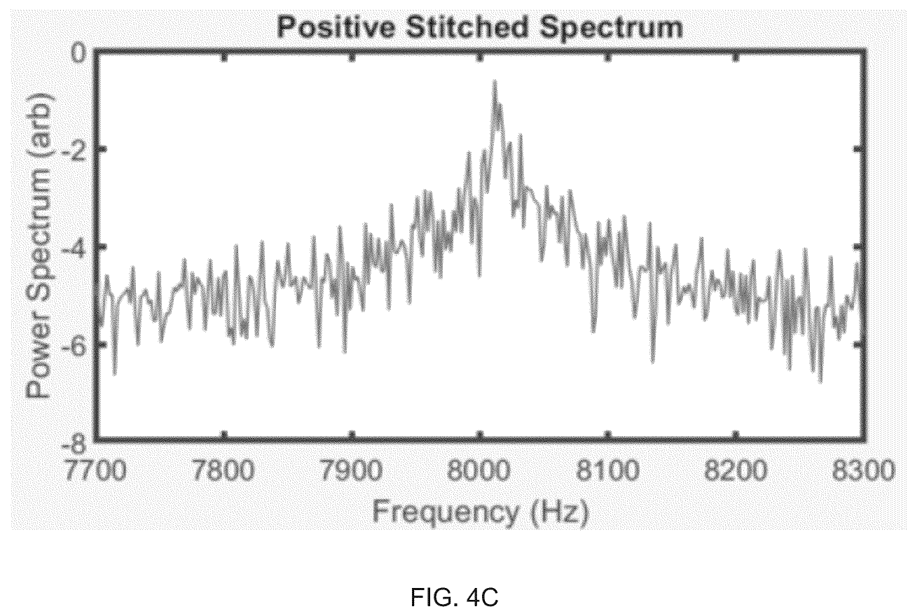

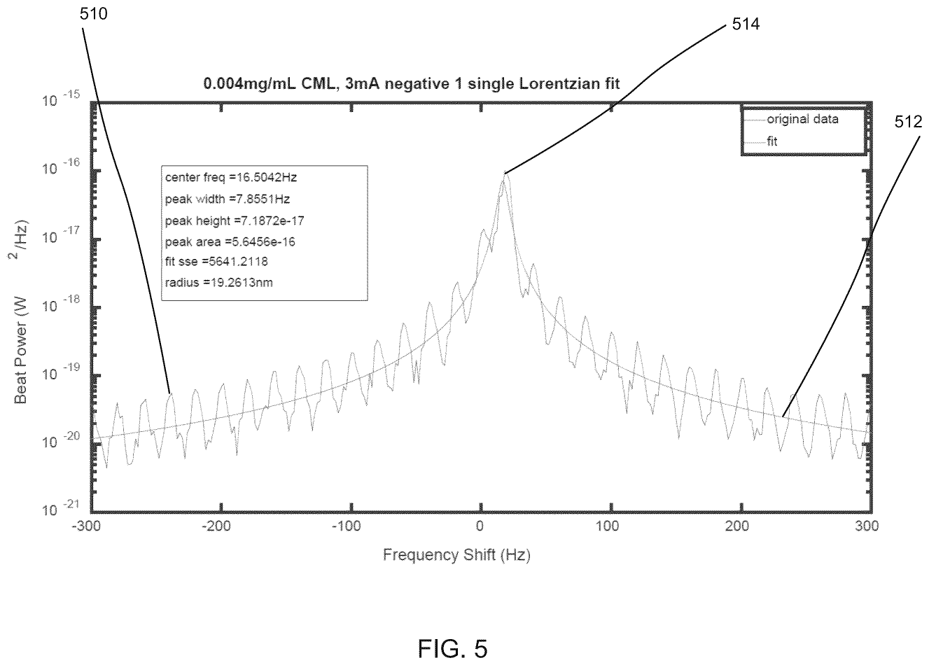

For example, FIG. 4A depicts splicing the intensity detector data into time segments, where the applied alternating electric field switches polarity every 50 ms, resulting in positive intensity detector data segments 410 and negative intensity detector data segments 412. In addition, for example, FIG. 4B depicts stitching together the positive intensity detector data segments 410, resulting in positive stitched data. Also, for example, FIG. 4C depicts applying a Fast Fourier Transform to the positive stitched data with respect to the beat signal, resulting in a positive stitched spectrum. Further, for example, FIG. 5 depicts fitting the positive stitched spectrum 510 to a fitting function, resulting in a positive fitted spectrum 512 and a positive center frequency of a positive peak position 514 of positive fitted spectrum 512 (e.g., a positive center frequency of 16.5042 Hz).

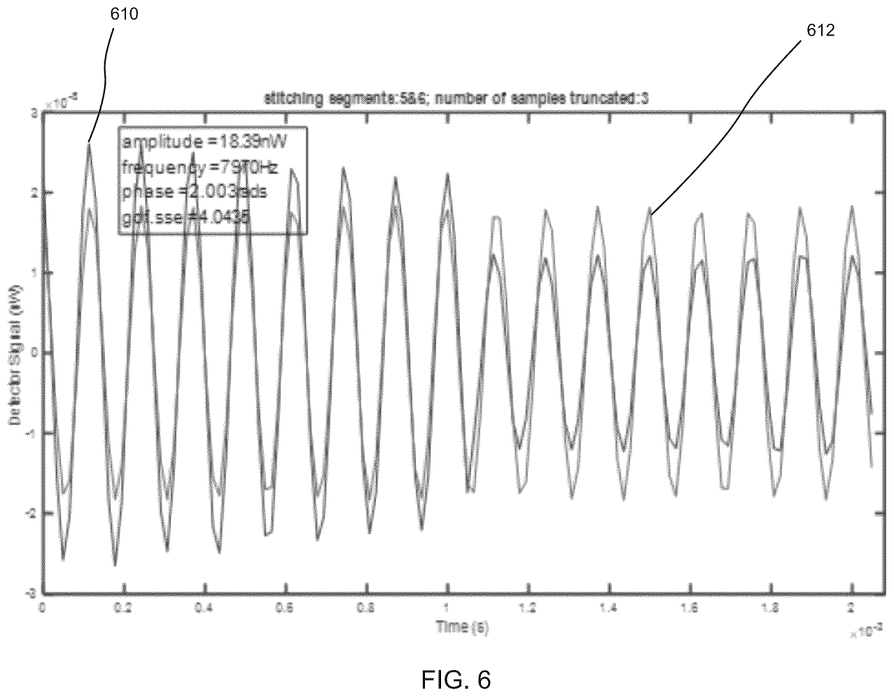

In another example, FIG. 6 depicts truncating the intensity detector data by removing three data points, leading to a low Sum of Squared Error (e.g., 4.0435) between the stitched together, truncated data 610 and the fitted data 612, thereby removing the artifacts/oscillations shown in FIG. 5. Also, for example, FIG. 6 depicts aligning the phase of the intensity detector data by removing three data points, leading to a low Sum of Squared Error (e.g., 4.0435) between the stitched together, phase aligned data 610 and the fitted data 612, thereby removing the artifacts/oscillations shown in FIG. 5.

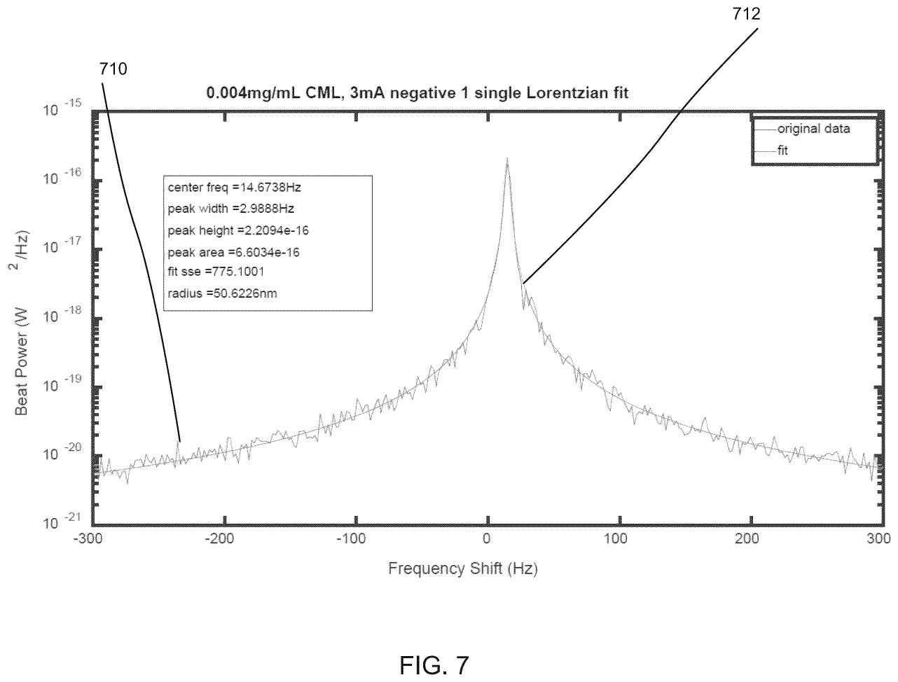

Further, for example, FIG. 7 depicts fitting an artifact free spectrum 710 of the intensity detector data after the truncating to a fitting function, as compared to positive stitched spectrum 510, resulting in a fitted spectrum 712. Also, for example, FIG. 7 depicts fitting an artifact free spectrum 710 of the intensity detector data after the truncating to a fitting function, as compared to positive stitched spectrum 510, resulting in a fitted spectrum 712.

### Computer System

In an exemplary embodiment, the computer system is a computer system 800 as shown in FIG. 8. Computer system 800 is only one example of a computer system and is not intended to suggest any limitation as to the scope of use or functionality of embodiments of the present disclosure. Regardless, computer system 800 is capable of being implemented to perform and/or performing any of the functionality/operations of the present disclosure.

Computer system 800 includes a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 812 may be described in the general context of computer system-executable instructions, such as program modules, being executed by a computer system. Generally, program modules may include routines, programs, objects, components, logic, and/or data structures that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in computer system 800 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 812 typically includes a variety of computer system readable media. Such media may be any available media that is accessible by computer system/server 812, and includes both volatile and non-volatile media, removable and non-removable media.

System memory 828 can include computer system readable media in the form of volatile memory, such as random access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions/operations of embodiments of the disclosure.

Program/utility 840, having a set (at least one) of program modules 842, may be stored in memory 828 by way of example, and not limitation. Exemplary program modules 842 may include an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the present disclosure.

Computer system/server 812 may also communicate with one or more external devices 814 such as a keyboard, a pointing device, a display 824, one or more devices that enable a user to interact with computer system/server 812, and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to: microcode, device drivers, redundant processing units, external disk drive arrays, RAID systems, tape drives, and data archival storage systems.

### Computer Program Product

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer implemented method comprising:
receiving, by a computer system, from a detector light intensity detector data corresponding to a sample as a function of time,
wherein the intensity detector data comprises a beat signal;
executing, by the computer system, a set of logical operations splicing the intensity detector data into time segments,
wherein a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments;
executing, by the computer system, a set of logical operations stitching together the positive intensity detector data segments, resulting in positive stitched data;
executing, by the computer system, a set of logical operations stitching together the negative intensity detector data segments, resulting in negative stitched data;
executing, by the computer system, a set of logical operations applying a Fast Fourier Transform to the positive stitched data with respect to the beat signal, resulting in a positive stitched spectrum;
executing, by the computer system, a set of logical operations applying the Fast Fourier Transform to the negative stitched data with respect to the beat signal, resulting in a negative stitched spectrum;
executing, by the computer system, a set of logical operations fitting the positive stitched spectrum to a fitting function, resulting in a positive center frequency of a positive peak position of the positive stitched spectrum;
executing, by the computer system, a set of logical operations fitting the negative stitched spectrum to the fitting function, resulting in a negative center frequency of a negative peak position of the negative stitched spectrum; and
executing, by the computer system, a set of logical operations processing the positive center frequency and the negative center frequency according to a processing function, allowing for calculating the electrophoretic mobility of particles of the sample.

2. The method of claim 1 wherein the detector is selected from the group consisting of a photodiode detector, a CMOS detector, a photomultiplier tube, and a balometer.

3. The method of claim 1 wherein a frequency of the beat signal changes in time and wherein a center frequency of the beat signal changes as a result of applying an alternating electric field to the sample.

4. The method of claim 1 wherein the Fast Fourier Transform is selected from the group consisting of a power spectrum and a periodogram.

5. The method of claim 1 wherein the fitting function comprises a non-linear, least square, Lorenz function.

6. The method of claim 1 wherein the processing function comprises a proportionality Function whereby the electrophoretic mobility of the particles of the sample is proportional to a difference between the positive center frequency and the negative center frequency.

7. A computer implemented method comprising:
receiving, by a computer system, from a detector light intensity detector data corresponding to a sample as a function of time,
wherein the intensity detector data comprises a beat signal;
executing, by the computer system, a set of logical operations splicing the intensity detector data into time segments,
wherein a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments;
executing, by the computer system, a set of logical operations truncating the positive intensity detector data segments to remove positive data artifacts from the positive intensity detector data segments, resulting in truncated positive data segments;
executing, by the computer system, a set of logical operations truncating the negative intensity detector data segments to remove negative data artifacts from the negative intensity detector data segments, resulting in truncated negative data segments;
executing, by the computer system, a set of logical operations stitching together the truncated positive intensity detector data segments, resulting in positive stitched data;
executing, by the computer system, a set of logical operations stitching together the truncated negative intensity detector data segments, resulting in negative stitched data;
executing, by the computer system, a set of logical operations applying a Fast Fourier Transform to the positive stitched data with respect to the beat signal, resulting in a positive stitched spectrum;
executing, by the computer system, a set of logical operations applying the Fast Fourier Transform to the negative stitched data with respect to the beat signal, resulting in a negative stitched spectrum;
executing, by the computer system, a set of logical operations fitting the positive stitched spectrum to a fitting function, resulting in a positive center frequency of a positive peak position of the positive stitched spectrum;
executing, by the computer system, a set of logical operations fitting the negative stitched spectrum to the fitting function, resulting in a negative center frequency of a negative peak position of the negative stitched spectrum; and
executing, by the computer system, a set of logical operations processing the positive center frequency and the negative center frequency according to a processing function, allowing for calculating the electrophoretic mobility of particles of the sample.

8. The method of claim 7 wherein the detector is selected from the group consisting of a photodiode detector, a CMOS detector, a photomultiplier tube, and a balometer.

9. The method of claim 7 wherein a frequency of the beat signal changes in time and wherein a center frequency of the beat signal changes as a result of applying an alternating electric field to the sample.

10. The method of claim 7 wherein the Fast Fourier Transform is selected from the group consisting of a power spectrum and a periodogram.

11. The method of claim 7 wherein the fitting function comprises a non-linear, least square, Lorenz function.

12. The method of claim 7 further comprising executing, by the computer system, a set of logical operations determining phase changes for the intensity detector data segments.

13. The method of claim 12 wherein the determining comprises executing, by the computer system, a set of logical operations applying sinusoidal functions to the intensity detector data segments, resulting in phase shift values corresponding to the phase changes associated with the truncating.

14. The method of claim 7 wherein the processing function comprises a proportionality function whereby the electrophoretic mobility of the particles of the sample is proportional to a difference between the positive center frequency and the negative center frequency.

15. A computer implemented method comprising:
receiving, by a computer system, from a detector light intensity detector data corresponding to a sample as a function of time,
wherein the intensity detector data comprises a beat signal;
executing, by the computer system, a set of logical operations splicing the intensity detector data into time segments,
wherein a duration of each of the time segments is a function of a rate of switching of an alternating electric field applied to the sample for measuring electrophoretic mobility of the sample, resulting in intensity detector data segments related to the electric field having a positive polarity resulting in positive intensity detector data segments, and intensity detector data segments related to the electric field having a negative polarity resulting in negative intensity detector data segments;
executing, by the computer system, a set of logical operations aligning a phase of the positive intensity detector data segments to remove positive data artifacts from the positive intensity detector data segments (to avoid discontinuities in time domain that would lead to artifacts in the frequency domain) (judicious truncation), resulting in phase-aligned positive data segments (adjust phase);
executing, by the computer system, a set of logical operations aligning a phase of the negative intensity detector data segments to remove negative data artifacts from the negative intensity detector data segments (to avoid discontinuities in time domain that would lead to artifacts in the frequency domain) (judicious truncation), resulting in phase-aligned negative data segments (adjust phase);
executing, by the computer system, a set of logical operations stitching together the phase-aligned positive data segments, resulting in positive stitched data;
executing, by the computer system, a set of logical operations stitching together the phase-aligned negative data segments, resulting in negative stitched data;
executing, by the computer system, a set of logical operations applying a Fast Fourier Transform to the positive stitched data with respect to the beat signal, resulting in a positive stitched spectrum;
executing, by the computer system, a set of logical operations applying the Fast Fourier Transform to the negative stitched data with respect to the beat signal, resulting in a negative stitched spectrum;
executing, by the computer system, a set of logical operations fitting the positive stitched spectrum to a fitting function, resulting in a positive center frequency of a positive peak position of the positive stitched spectrum;
executing, by the computer system, a set of logical operations fitting the negative stitched spectrum to the fitting function, resulting in a negative center frequency of a negative peak position of the negative stitched spectrum; and
executing, by the computer system, a set of logical operations processing the positive center frequency and the negative center frequency according to a processing function, allowing for calculating the electrophoretic mobility of particles of the sample.

16. The method of claim 15 wherein the detector is selected from the group consisting of a photodiode detector, a CMOS detector, a photomultiplier tube, and a balometer.

17. The method of claim 15 wherein a frequency of the beat signal changes in time and wherein a center frequency of the beat signal changes as a result of applying an alternating electric field to the sample.

18. The method of claim 15 further comprising executing, by the computer system, a set of logical operations determining phase changes for the intensity detector data segments.

19. The method of claim 15 wherein the determining comprises executing, by the computer system, a set of logical operations applying sinusoidal functions to the intensity detector data segments, resulting in phase shift values corresponding to the phase changes associated with the aligning.

20. The method of claim 15 wherein the processing function comprises a proportionality function whereby the electrophoretic mobility of the particles of the sample is proportional to a difference between the positive center frequency and the negative center frequency.
